(19) United States
(12) Patent Application Publication
(10) Pub. No.: US 2023/0357086 A1
(43) Pub. Date: Nov. 9, 2023

(54) A System and Method for the Production of High Strength Materials

(71) Applicant: CALIX LTD, Pymble (AU)

(72) Inventor: Mark Sceats, Pymble (AU)

(21) Appl. No.: 17/610,399

(22) PCT Filed: May 13, 2020
(86) PCT No.: PCT/AU2020/050471

§ 371 Date: Nov. 10, 2021

(30) Foreign Application Priority Data
May 14, 2019 (AU) 2019901645

(51) Int. Cl. C04B 35/645; C04B 35/626; C04B 35/111; C04B 35/053; C04B 35/575

(52) U.S. Cl. CPC C04B 35/053; C04B 35/111; C04B 35/575; C04B 35/62645; C04B 35/645; C04B 2235/3206; C04B 2235/3217; C04B 2235/3826; C04B 2235/5463; C04B 2235/61; C04B 2235/77; C04B 2235/781

(57) ABSTRACT

The invention provides a process for manufacturing ceramics and refractories comprising the steps of producing a porous powder comprising nanograin sized particles wherein the particles have a Young’s modulus value that is smaller in value compared to the same crystalline material; compacting and processing the powder such that the powder forms a stable homogeneous composite; and sintering the composite for a time and temperature to lead to uniform shrinkage of the composite to make a dense homogenous material.

### TECHNICAL FIELD

The present invention relates broadly to an approach to production of high strength materials, and in particular ceramics and refractory materials.

The objective is to develop an approach to making materials that are stronger than materials fabricated using conventional approaches, with lower production costs, and lower energy consumption and carbon emissions.

### BACKGROUND

There has been a long history for the production of high strength ceramics, including refractory materials.

More recently the development of these materials from nano-particles has been developed. The benefits of using nano-particles of the material to be fabricated into a ceramic material as the starting point of the production process of such materials is that the initial grains of the material are on the nanometer scale compared to the micron scale of most powders. The higher surface energy of such grains means that there is an enhancement by orders of magnitude of the driving force for sintering the materials into a compact material. This prior art notes that a consequence is that the sintering process occurs at much lower temperatures, and the sintering time is greatly reduced because the diffusion processes only have to occur on the nano-meter length scale compared to microns for the conventional approach. To maximise the strength of the material, the most desirable approach is to produce a high-density composite of such small grains. However, generally the use of nanomaterials has a problem that nanoparticles tend to form agglomerates so the initial packing density is inhomogeneous so that, during sintering, macropores pores are developed from this initial aggregation, and the time and temperature for these pores to be eliminated becomes similar to those for conventional materials, with the pores creating centres for coarsening of the material. Therefore, the promise of high-performance ceramics has not been met using nano-particles as the initial material. The cost of production and handling of nanoparticles is such that this approach to manufacture of ceramics is not used industrially. It is noted that many powders that are used for making ceramics are produced by calcination of a precursor whereby a volatile constituent is driven off, leading to a porous material. In this case, the calcined powder is itself sintered to remove the micropores, mesopores and macropores of such particles, so that these particles are dense, and are called “dead-burned”. When these hard particles, characterised by a Young’s modulus of the crystal, are formed into an initial composite for sintering, the pores that must be removed by sintered are the interparticle pores of the composite, which is on the length scale of the particles.

There is a need for an approach in which sintering occurs on the nanoscale for high strength, and the formation of large pores is minimised so that the sintering occurs homogeneously to realise the intrinsic benefits of nanoscale sintering described above.

Any discussion of the prior art throughout the specification should in no way be considered as an admission that such prior art is widely known or forms part of common general knowledge in the field.

### SUMMARY

According to a first aspect, the invention provides a process for manufacturing ceramics and refractories comprising the steps of:
a) producing a porous powder comprising nano-grain sized particles wherein the particles have a Young’s modulus value that is smaller in value compared the same crystalline material;
(b) compacting and processing the powder such that the powder forms a stable homogeneous composite; and
(c) sintering the composite for a time and temperature to lead to uniform shrinkage of the composite to make a dense homogenous material.
Preferably, the powder comprises particles with a size distribution of between 0.1 to 100 microns. More preferably, the powder comprises particles with a size distribution of between of 1 to 20 microns.

Preferably, the porosity of the particles of the invention is between 0.4% to 0.7%. In a preferred embodiment of the invention, the Young’s modulus is less than 10% of that of the crystal value of the same crystalline material.

In one embodiment, the powder is produced by flash calcination of a precursor material in which volatile materials are released to develop porosity.

In this preferred embodiment, the calcined powder is flash quenched to minimise the grain size.

In an alternative preferred embodiment, step (b) of the process additionally comprises the steps of:
(b1) maximising bulk density of the powder by shaking the powder in a device; and
(b2) applying pressure to produce the homogeneous composite wherein the conditions are chosen to limit the growth of the nano-grain size of the powder during this process.
More preferably, the process further comprises controlling temperature conditions to limit the growth of the grain size of the powder. In another preferred embodiment, the process further comprises the use of additives such that the composite does not significantly expand or fragment when pressure is released.

The shape of the device is preferably designed for as specific use of the processed material, including the use of shapes formed by additive manufacturing techniques. In another alternative embodiment, the processes of steps (b) and (c) according to the first aspect occur in a single process.

Preferred powders are magnesium oxide, aluminium oxide, or silicon carbide. A mixture of these powders may also be used. In a particularly preferred embodiment, the precursor used to produce the powder is magnesium carbonate and stream is produced by the decomposition of magnesium hydroxide. Steam is preferably formed by the reaction of water vapour in the calcination process. In a particularly preferred process, the powder comprises at least one nano-active material.

This invention discloses a novel approach for manufacturing ceramics, including refractories, encompassing the steps of:-
a. Producing nano-active powder particles to form the initial composite. In this invention, nano-active particles means powders that have a typical size distribution from 0.5 to 100 microns, and have a high porosity of between 0.5%-0.7% and have surface area in the range of 50-300 m²/g, such that the mean grain size within each of the particles, derived from these properties and the material density of the particles, if the order of 5-30 nm, with a minimum grain size distribution. A property of these particles is that the Young’s modulus of the particle, as measured by nano-indentation, is on the order of 2-10% of the same crystalline material.
b. Compressing the composite to produce a material which is close to being a homogeneous material in which the mesopores, macropores of the particles, and inter-particle pores have been eliminated by the application of pressure. It is preferable that the composite does not significantly expand when the pressure is relieved, and this objective can be realised by the inherent ability of the high surface area materials to form inter-particle bonds under pressure or by the presence or addition of small amounts of materials that will bind the particles. It may be that this stage of production occurs at a modest pressure to aid such bonding. The reduction of the pores on the nano-scale is not a requirement of the compression, but some reduction will occur as the number of grain contacts increases from 2-4 towards 6 for spherical grains, depending on the production process of the material. Any heating used in this process is used to facilitate the formation of such contacted grains. Rather it is most desirable that the compressed material is homogenous and is formed from nano-grains that have a small size distribution. It would be apparent to a person skilled in the art that the low Young’s modulus of the particles is the property of the material that enables the particles to deform under pressure to eliminate the pores described above without the need for large scale change of the grain size distribution. It is desirable that gas entrained in the pores is continuously removed during compression to avoid bubble formation. The means of such compression of powders is a known art. For example, it is desirable that the particle size distribution is sufficiently broad that the tapped density of the porous particles before compression is high.
c. Sintering of the homogenous composite under temperature where the high surface energy of the grains is the driving force that leads to a uniform shrinkage of the composite to make a dense homogenous material. A person skilled in the art would recognise that a homogenous material with nanopores will compact by shrinking uniformly, and this will occur by atomic diffusion so that the grain contact area grows and as the material densifies, the average number of grain contacts grows towards 14. It is preferable that the material sinters with minimum coarsening of the grain sizes, and this is minimised by achieving minimal grain size distribution during preparation of the nano-active powder. As above, the elimination of gas during heating may be preferable so that closing off of the residual nano-pores does not generate an internal pressure that may impede densification.

### Problems to be Solved

It may be advantageous to produce high strength ceramics from nano-active powder materials which can be produced by flash calcination of precursor powders in which produce porous, high surface are materials suitable for such ceramics, with a broad particle size distribution that facilitates a high tapped density by minimising the interparticle pores.

It may be advantageous to produce high strength ceramics from such nano-active powders in a sintering process in which, firstly a composite of packed powder is made homogeneous by eliminating mesopores, macropores and interparticle pores by the application of pressure, assisted by heat, such that there is an irreversible binding of the materials are the interfaces between these pores, where such conditions minimises coarsening of the grain size; and secondly sintering such a homogeneous composite under conditions of time and temperature in which the grain contacts grow to produce a high strength materials by uniform, densification.

It may be advantageous to undertake the sintering process in a continuous process in which the pressure and temperature variations are varied to optimise the materials, wherein the two-step sintering process described above occurs continuously.

### Means for Solving the Problem

One embodiment of the invention concerns the production of nano-active materials. The flash calcination process described by Sceats and Horley in WO 2007/112496 (incorporated herein by reference) can be used to make such materials from a precursor material. While the WO2007/112496 invention was applied to processing of carbonate mineral materials, the same process can be used to process synthetic materials, as well as other minerals. The primary requirement is that the precursor material contains volatile materials such as carbonates, hydroxyl, ammonia, nitrates and organic ligands and water of hydration, such that the porosity of the processed material is in the range of 0.4%-0.7%. A second preferable requirement is that the precursor, the gas environment and temperature is selected so that there are no phase changes that may occur, which would lead to the formation of larger pores from the smaller pores as the phase change takes place, as a consequence of reactive sintering. It is noted that flash quenching of the calcined material is preferable to inhibit sintering. The processing conditions may be chosen to reduce particle fragmentation during calcination. The primary requirement of this stage is to produce a material with a uniform distribution of nano-grains.

A second embodiment of the invention is the processing of composites of nano-active materials, where the first stage is to remove particle mesopores and macropores and interparticle pores by the application of pressure, and temperature, where the conditions are selected to produce a homogenous material in which the nano-grains are surrounded by nano-pores and the coarsening of the grains is minimised and the elimination of all other pores is maximised; and a second stage is the application of heat to uniformly densify the by minimising grain coarsening and maximising the number of grain-grain contacts as the means of eliminating the porosity.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 depicts a flowchart illustrating a process for manufacturing ceramics and refractories using a flash calcining process according to an example embodiment.

FIG. 2 depicts a schematic cross-sectional drawing of a calciner reactor according to an example embodiment;

### DESCRIPTION OF THE INVENTION

Preferred embodiments of the invention will now be described by reference to the nonlimiting examples.

The process of a preferred embodiment of the present invention comprises the steps of producing a porous powder comprising nano-grain sized particles. The particles of the powder are designed to have a Young’s modulus value that is smaller in value compared the same crystalline material. This is the property of the material that enables the particles to deform under pressure to eliminate the pores described above without the need for large scale change of the grain size distribution. The powder is treated to form a stable homogeneous composite, and sintered for a time and temperature to lead to uniform shrinkage of the composite to make a dense homogenous material. The conditions of pressure, and temperature are selected to minimise the coarsening of the nano-grain size and eliminate all other pores as far as possible to maximise grain to grain contact. The porous powder preferably comprises particles with a size distribution of between 1 to 20 microns, with a porosity between 0.4% to 0.7% and a Young’s modulus less than 10% of that of the crystal value of the same crystalline material.

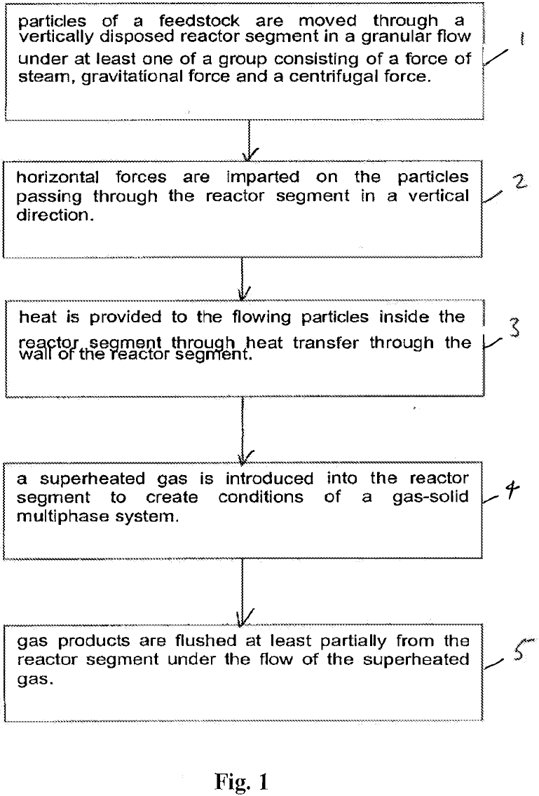

A preferred embodiment of the invention is a process for manufacturing ceramics and refractories using flash calcination. A flow chart of an exemplary process is outlined in FIG. 1. The example embodiments described using flash calcination provide a continuous calcination system and method. The described embodiments provide a system and process that takes advantage of both the faster chemical kinetics engendered by the catalytic effect of superheated steam in association with a small particle size, and the use of the superheated steam for gas phase heat transfer. As shown in steps outlined FIG. 1, feedstock particles move in a granular flow through a vertical reactor segment by forces such as steam, gravity or a centrifugal force. Horizontal forces are thereby imparted on these particles passing through the reactor segment in a vertical direction. As the particles flow inside the reactor segment, heat is provided to the particles via heat transfer through the walls of the reactor segment. A superheated gas may be introduced into the reactor segment to create conditions of a gas-solid multiphase system. Gas products can be at least partially flushed from the reactor segment under the flow of the superheated/gas.

At the same time, however, the described embodiments are designed such that the dominant mechanism of heat transfer is from the walls of the calciner directly to the particles as a result of two major factors. That is, the heat transfer arising from the strong interaction of the particles with the gas engendered by the large centrifugal forces acting on the particles and resultant friction with the gas that is imparted to the walls of the reactor tube, and the heat transfer arising from the radiation heating of the particles. The granular flow through the helical tube is significantly slower than through an equivalent straight tube, and this not only generates the friction required for the above first mechanism for heat transfer, but also controls the transit time through the reactor to allow the heat transfer to take place efficiently. Thus, a helical tube can process a higher throughput than a linear tube of the same diameter and length.

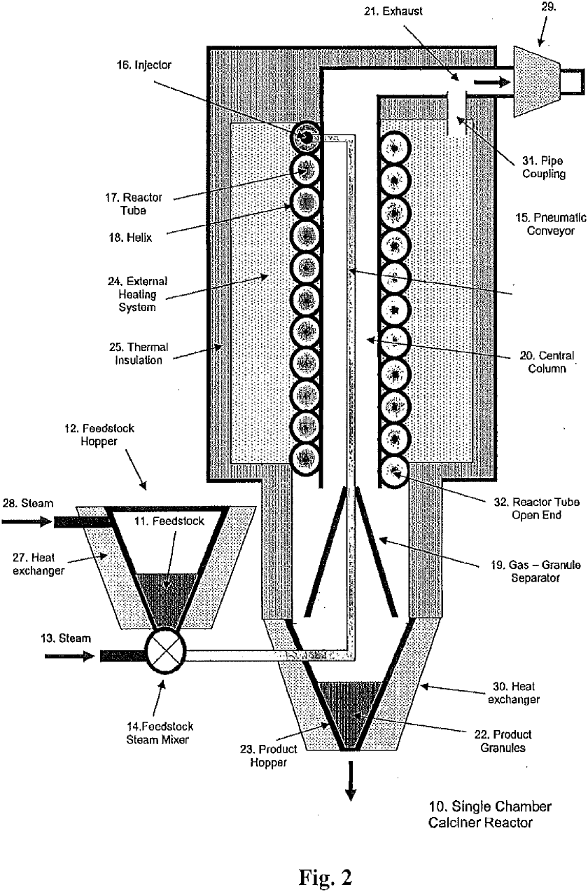

The calciner reactor 10 described in FIG. 2 is more generally applicable to calcining minerals other than limestone. A broad statement is that calcination is the chemical process that is activated by heat, and includes dehydration as well as decarbonation, with or without superheated steam. Starting materials can be carbonates, but hydroxides, as in the present invention, also calcine to oxides, and hydrated materials are dehydrated. In many chemical reactions (other than dehydration), superheated steam is quite likely to assist most such processes because the water molecule is a well-established labile ligand to mostly all metal ions, and therefore chemical intermediates Involving water may be engendered by the presence of superheated steam. Even where the catalysis does not occur, there may be advantages in using the process of the described embodiments in which the role of superheated steam, or other injected gases, is principally to promote the transfer of heat to the particles. That is, generally, the fine grinding of feedstock will remove the impact of heat transfer and mass transfer process of decomposition, and enhance the chemical reaction step. The operating conditions of the calciner reactor 10 described can be readily adapted to any calcination process in which the calcination can be accommodated within the residence time of feedstock passing through the system.

FIG. 2 shows a single segment vertical calciner reactor 10. The feedstock indicated at 11 is produced from rocks and ores that have been dried, crushed and pre-ground. A feedstock size distribution with a mean size in the range of about 40 microns to about 250 microns is achieved by a conventional cyclone system (not shown) with a crusher and grinder (not shown). The feedstock- 11 is collected in a Feedstock Hopper 12 and is mixed with superheated steam 13 in mixer 14 and conveyed pneumatically through a conveyor tube 15 to an injector 16 at the top of the reactor where it is injected into the reactor tube 17. The injector 16 thus functions as both, feeder for the particles into the reactor tube 17, and as an inlet for superheated steam 13 into the reactor tube 17.

It will be appreciated that additional inlets may be provided along the tube 17 in different embodiments for feeding super-heated steam into the reactor tube 17. The reactor tube 17 is formed into a helix 18, and preferably the helix 18 is formed into a structure which forms a leak proof central column 20. The helix 1 imparts horizontal forces on particles passing through the reactor 10 in a vertical direction. The reaction proceeds in the reaction tube 17 to the desired degree. The superheated steam, the product particles and the reaction gases flow out of the open end 32 of tube 17 and through to the gas-particle separator 19. The reaction tube 17 and the gas-particle separator form a reactor segment in this example embodiment. The gas motion is reversed and the gases are exhausted into the central column 20 by the vortex formed in the separator 19 as a result of the centrifugal forces induced in the helix 18.

It will be appreciated that additional exhaust openings may be provided along the tube 17 in different embodiments. The exhausted gases in the central column 20 heat the steam 13 and feedstock 11 being conveyed to the injector 16 before the gases are exhausted at the top of the reactor 21, The exhaust gases can be processed by condensing the steam in a condenser 29 and compressing the gas for other uses. The product particles 22 are collected in the hopper 23, and are rapidly cooled using heat exchanger 30, e.g. with the water used to produce the steam. The reactor tube 17 is heated externally by a heat source 24, and the reactor is thermally insulated 25 to minimise heat loss.

The flow rates of the superheated steam in the calcination process are set so as to maximise the degree of calcination. In FIG. 2, the steam moves in the same direction as the particles, so that the steam has maximum impact on the reaction rate at the top of the reactor 10, and this effect decreases through the reactor 10 as the steam is diluted by the reaction gases and the pressure drops as a result of the friction along the tube 17.

The temperature of the particles during transportation in a flash calcination process is preferably kept sufficiently low to ensure that both the steam catalysed calcination reaction and the sintering by steam heat is minimised, and the adsorption of steam maximised, while the steam temperature is preferably kept sufficiently high so that the steam does not condense. The travel time of the particles down the gravity feed calciner is between 1 to 15 seconds, preferably about 6 seconds.

The temperature of the calciner walls is maintained at the desired calcination temperature by heating the outer wall of the reactor tube 17, as shown in FIG. 2. When multiple reactor chambers are used, the average temperatures for each chamber may be different and each chamber may operate with a temperature gradient. There are several means of achieving the external heating, with the design of external heating systems being a known art. The helix 18 provides a large external surface area, and the control of the temperature can provide the system with a uniform thermal load. It is preferable that the thermal load be less than about 50 kW/m². Where distributed frameless heating is used, the suppression of pyrolysis can be achieved by feeding a portion of the calciner exhaust into the fuel in the external heating system 24 via a pipe connection 31 coupled to the exhaust 21, to control the rate of production of heat.

For example, it is often desirable that the temperature near the base of the calciner reactor 10 is larger than that at the top. Near the injector 16, the CO partial pressure is small, and the reaction rate is faster than at the base, so that for a constant thermal load, the temperature at the top can be lower than the base. This can be achieved by injection of the fuel near the base, so that the flow of gas in the external heater system 24 is in counterflow to the flow of gas and solids in the tube 17. In another such example system, the heat is produced electrically by applying a voltage between an upper portion and a lower portion of the tube 17 with a current supplied to heat the reactor tube 17 by its electrical resistivity.

In another example system, the heat is produced by burners arrayed around the external surface of the tube 17 so as to produce the desired temperature distribution along the reactor tube 17. In another example system, the heat is provided by a heat exchanger from a heat exchange fluid, such as compressed carbon dioxide. In another example, oxygen is used instead of air. A combination of such systems may be used.

In one embodiment, the powder of the present invention is produced by flash calcination of a precursor material in which volatile materials are released to develop porosity. In this preferred embodiment, the calcined powder is flash quenched to minimise the grain size.

In an alternative preferred embodiment, step (b) of the process additionally comprises the steps of: (b1) maximising the bulk density of the powder by shaking the powder in a device; and (b2) applying pressure to produce a homogeneous composite material wherein the conditions are chosen to limit the growth of the nano-grain size of the powder during this process. The shape of the device may be designed for as specific use of the processed material, including the use of shapes formed by additive manufacturing techniques. In another alternative embodiment, the processes of forming and sintering the composite material occur in a single process.

Preferred powders are magnesium oxide, aluminium oxide, or silicon carbide. A mixture of these powders may also be used.

The first example embodiment is the production of magnesium oxide ceramics. In this example, the nano-active material is made by the calcination of the mineral magnesite (magnesium carbonate) as the precursor. Steam is produced by the decomposition of magnesium hydroxide. Steam is preferably formed by the reaction of water vapour in the calcination process. In a particularly preferred process, the powder comprises at least one nano-active material. This application is described in the Sceats Horley invention, and is known to produce a material with the desired physical properties of nano-grains of crystals of magnesia (MgO).

A nanoparticle or ultrafine particle is typically understood as a particle of matter that is between 1 and 100 nanometres (nm) in diameter. Nanoparticles are distinguished from “fine particles”, sized between 100 and 2500 nm, and “coarse particles”, ranging from 2500 to 10,000 nm. Nanoparticles are much smaller than the wavelengths of visible light (400-700 nm), and require an electron microscope to be seen. Dispersions of nanoparticles in transparent media can be transparent. Nanoparticles also easily pass through common filters, such that separation from liquids requires special nanofiltration techniques.

The properties of nanoparticles very often differ markedly from those of larger particles of the same substance. Since the typical diameter of an atom is between 0.15 and 0.6 nm, a large fraction of the nanoparticle’s material lies within a few atomic diameters from its surface. Therefore, the properties of that surface layer may dominate over those of the bulk material. This effect is particularly strong for nanoparticles dispersed in a medium of different composition, since the interactions between the two materials at their interface also becomes significant.

The exemplary powder of the present invention can be ground by conventional processes to meet the desired broad particle size distribution that maximises the tapped density of the porous powder. The powder is selected to have a high porosity so that calcination proceeds quickly at low temperature and thermal sintering of the powder is minimised. During the calcination processes there are macropores in the initial magnesite powder that expand as the calcination proceeds, and adjacent grains form necks to produce a stable particle by further expansion of the macropores. Flash quenching of the powder further supresses sintering, and some moisture is introduced to enable the formation of magnesium hydroxide, at about 1% mole/mole as the powder is cooled.

Nano-indentation of the particles shows that the particle Young’s modulus is about 5% of that of the crystal value. Thus, the nanograin array has the flexibility to re-arrange under modest pressure. In this example, the composite is made by concentrating the powder by tapping and applying sound and ultrasound to maximise the bulk density of the powder. The process further comprises controlling temperature conditions to limit the growth of the grain size of the powder. In another preferred embodiment, the process further comprises the use of additives such that the composite does not significantly expand or fragment when pressure is released.

In the second step, the powder is put under pressure, of about 1-10 MPa, and the temperature is raised to about 300° C. so activate a binding process which arises from the release of water vapour, and this process activates the MgO to bind the particles under pressure, so that as the pressure is relived and the temperature is reduced, the composite does not expand significantly.

Microscope analysis and light scattering shows that the composite is substantially uniform, and a comparison of the Small Angle X-ray Scattering of the powder and composite shows that the material gain size has remained on the nano-scale with a small change of the grain size distribution. The composite is heated in a furnace and the densification is measured as a function of temperature and time. The temperature and time are consistent with traditional sintering kinetics, but are significantly lower because the diffusion of material is on the nano-scale, rather than the micron-scale of MgO ceramics and refractories. For example, the sintering temperature is reduced from 1500° C. to 1000° C. and the time is reduced from hours to minutes.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1. A process for manufacturing ceramics and refractories comprising the steps of:
(a) producing a porous powder comprising nano-grain sized particles with a Young’s modulus less than 10% of that of a same crystalline material;
(b) compacting and processing the powder such that the powder forms a stable-homogeneous composite; and
(c) sintering the composite for a time and temperature to lead to uniform shrinkage of the composite to make a denser homogenous material to a required specification of density and strength.

2. The process of claim 1 wherein the powder comprises particles with a size distribution of between 0.1 to 100 microns.

3. The process of claim 2 wherein the powder comprises particles with a size distribution of between 1 to 20 microns.

4. The process of claim 1, wherein porosity of the particles is between 0.4 to 0.7.

5-6. (canceled)

7. The process of claim 1 wherein step (b) additionally comprises the steps of:
(b1) maximizing bulk density of the powder by shaking the powder in a device; and
(b2) applying pressure to produce the homogeneous composite wherein conditions are chosen to limit growth of a nano-grain size of the particles during this process.

8. The process of claim 7 wherein temperature conditions are controlled to limit the growth of the nano-grain size of the particles.

9. The process of claim 8 wherein the composite does not expand or fragment when pressure is released.

10. The process of any one of claim 7, wherein a shape of the device is designed for as specific use of the homogeneous material, including the use of shapes formed by additive manufacturing techniques.

11. The process of claim 1 wherein the steps (b) and (c) occur simultaneously.

12. The process of claim 1, wherein the porous powder is magnesium oxide.

13. The process of claim 12, wherein porous magnesium oxide powder in produced by flash calcination of ed-magnesium carbonate or magnesium hydroxide, and cooled by flash quenching.

14. (canceled)

15. The process of any one of claim 1, wherein the porous powder is aluminium oxide.

16. The process of any one of claim 1, wherein the porous powder is silicon carbide.

17. The process of claim 1, wherein the powder comprises at least one material comprising nano-grain particles with a Young’s modulus less than 10% of that of the same crystalline material.

18. The process of claim 15, wherein the porous aluminium oxide powder is produced by flash calcination of aluminium hydroxide or gibbsite, and preferably cooled by flash quenching.
